(19) United States
(12) Patent Application Publication
(10) Pub. No.: US 2008/0049945 A1
(43) Pub. Date: Feb. 28, 2008

(54) SYSTEM FOR BINAURAL HEARING ASSISTANCE

(75) Inventors: Stefan Haenggi, Murten (CH); Francois Marquis, Oron-le-Chatel (CH); Herbert Baechler, Meilen (CH)

Correspondence Address: ROBERTS, MLOTKOWSKI & HOBBES, P. O. BOX 10064, MCLEAN, VA, 22102-8064, US

(73) Assignee: Phonak AG, Staefa (CH)

(21) Appl. No.: 11/467,233

(22) Filed: Aug. 25, 2006

(51) Int. Cl. H04R 5/00

(52) U.S. Cl. 381/26

(57) ABSTRACT

There is provided a system for providing binaural hearing assistance to a user, comprising a left ear unit to be worn at or in the user's left ear, a right ear unit to be worn at or in the user's right ear, each of the left ear unit and the right ear unit comprising means for stimulating the user's hearing and an inductive antenna for enabling bidirectional communication between the left ear unit and the right ear unit via an inductive link, which antenna has an axial symmetry axis which is oriented substantially vertically and which is substantially parallel to the antenna of the other one of the left ear unit and right ear unit, the system further comprising at least one device to be worn by the user which comprises an inductive antenna for enabling communication between the device and at least one of the left ear unit and the right ear unit via an inductive link, which antenna has an axial symmetry axis which is oriented substantially vertically and which is substantially parallel to the antennas of the left ear unit and right ear unit.

### BACKGROUND OF THE INVENTION

1. Field of the Invention

The present invention relates to a system for providing binaural hearing assistance to a user comprising a left ear unit to be worn at or in the user's left ear and a right ear unit to be worn at or in the user's right ear, wherein each of the left ear unit and the right ear unit comprises means for stimulating the user's hearing and an inductive antenna for enabling bidirectional communication between the units via an inductive link.

2. Description of Related Art

US 2005/0232454 A1 relates to such a binaural system wherein two in-the-ear (ITE) hearing aids are provided with antenna coils in such a manner that the symmetry axes are oriented substantially horizontally and coaxially with respect to each other when the hearing aids are worn in the user's ear canals in order to optimize the inductive coupling between the two antennas. This is particularly important in view of the relatively restricted power budget of hearing aids. A similar binaural system is described in US 2005/0238190 A1.

It is also known to provide hearing aids with a coil antenna which is oriented substantially vertical in order to pick up the inductive signals produced by the coil of the receiver of a telephone headset. Such inductive coils in hearing aids are known as “T-coils”. Examples for hearing aids equipped with T-coils are found in US 2006/0029248 A1, U.S. Pat. No. 5,557,673 and US 2005/0244024 A1.

A vertical antenna integrated into the housing of a behind the ear (BTE) hearing aid for bidirectional communication with a remote programming device is described in US 2002/0191806 A1, wherein the hearing device may be part of a binaural system. The receiver/transmitter unit connected to the antenna is removed from the hearing aid during times when no communication with the remote programming unit is necessary.

US 2004/0028251 A1 relates to a hearing aid comprising an antenna coil wound around the housing of the hearing aid microphone or the hearing aid loudspeaker for communication with a remote device. The hearing aid may be part of a binaural system.

U.S. Pat. No. 6,594,370 B1 relates to a wireless communication system comprising two ear pieces which communicate wirelessly with a remote processor unit worn at the neck. A necklace is provided into which patch antenna arrays are integrated for establishing a wireless link to the ear pieces.

It is also known to design a remote control for hearing aids as a wrist watch-like device, wherein the antenna for providing a wireless link to the hearing aid is integrated within the band of the wrist-watch. An examples for such a remote control is given in U.S. Pat. No. 4,947,432.

It is an object of the invention to provide for a binaural hearing assistance system wherein bidirectional communication between the left ear unit and the right ear unit and in addition communication with a body worn device is enabled at a relatively small power budget.

### SUMMARY OF THE INVENTION

According to the invention this object is achieved by a system as defined in claim 1 and in claim 16, respectively.

The solution according to claim 1 is beneficial in that, by arranging the antennas of the right ear unit and the left ear unit in a substantially vertical, parallel orientation and by arranging the antenna of the body-worn device in a substantially vertical orientation parallel to the antennas of the of the right ear unit and the left ear unit, the inductive coupling between the body-worn device and the right ear unit and/or left ear unit is optimized while still an acceptable inductive coupling between the right ear unit and the left ear unit is achieved. Although the efficiency of the inductive coupling between the right ear unit and the left ear unit is reduced compared to the case of a horizontal axially aligned arrangement of the antennas, the overall performance of the system can be improved by such vertical antenna arrangement. One reason is that the inductive coupling to the body-worn device can be improved due to the fact that usually a vertical antenna arrangement can be realized more easily in the body-worn device than a horizontal antenna arrangement. Another reason is that for a vertical antenna arrangement the left ear unit and the right ear unit usually allows for more antenna space, so that the reduced inductive coupling can be compensated by an extended length of the antennas. Such extended antennas can be realized particularly easy for BTE hearing aids.

The solution according to claim 16 is beneficial in that, by orienting the antennas of the left ear unit and the right ear unit substantially horizontally and substantially aligned to each other and by orienting the antenna of the body-worn device substantially horizontally and substantially parallel to the antennas of the left ear unit and the right ear unit, an optimized inductive coupling both between the left ear unit and the night ear unit and the body-worn device is achieved.

These and further objects features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic view of a first embodiment of a binaural system according to the invention comprising a left ear unit and the right ear unit and several examples of body-worn devices;

FIG. 2 is a view like FIG. 1 of a second embodiment;

FIG. 3 is a block diagram of an example of a left ear/right ear unit to be used in the embodiment of FIG. 1 or 2; and

FIG. 4 is a block diagram of an example of remote device to be used in the embodiment of FIG. 1 or 2.

### DETAILED DESCRIPTION OF THE INVENTION

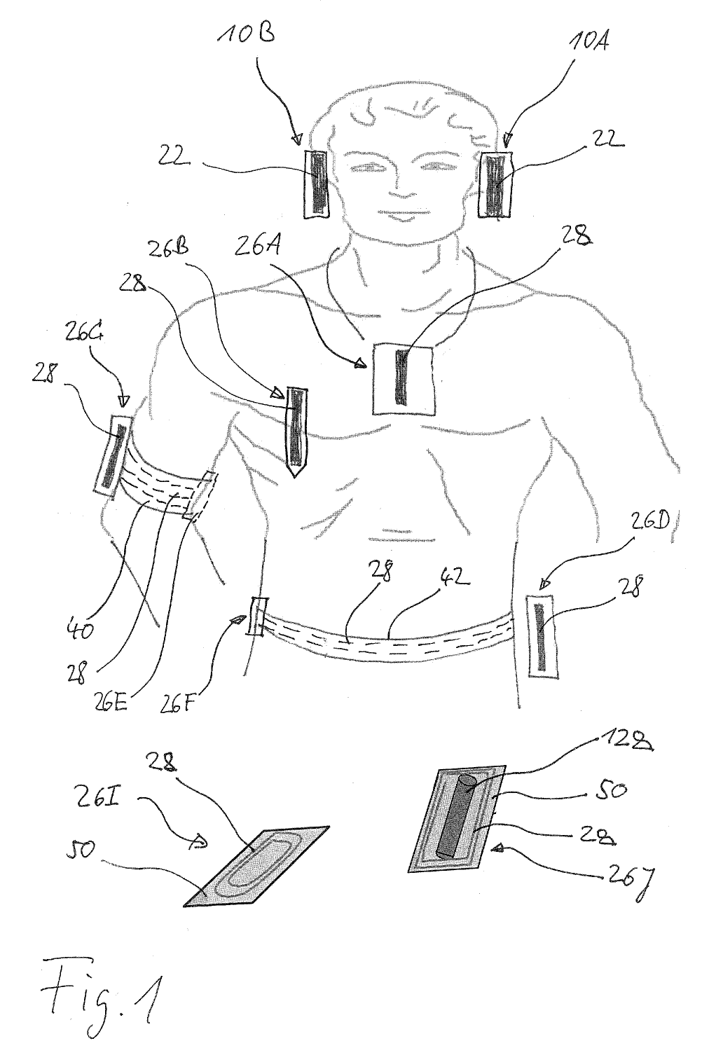

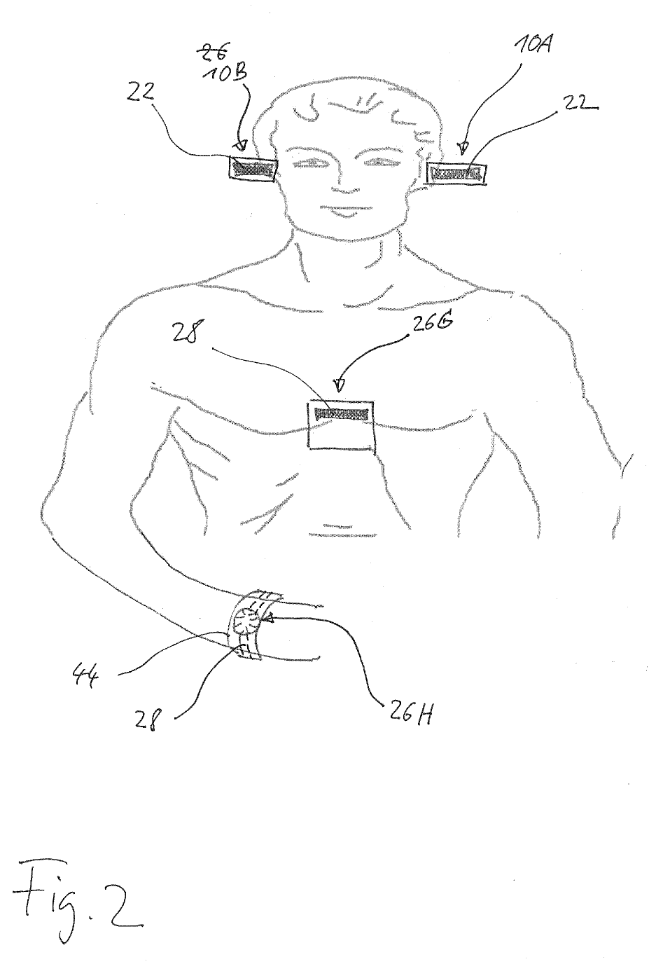

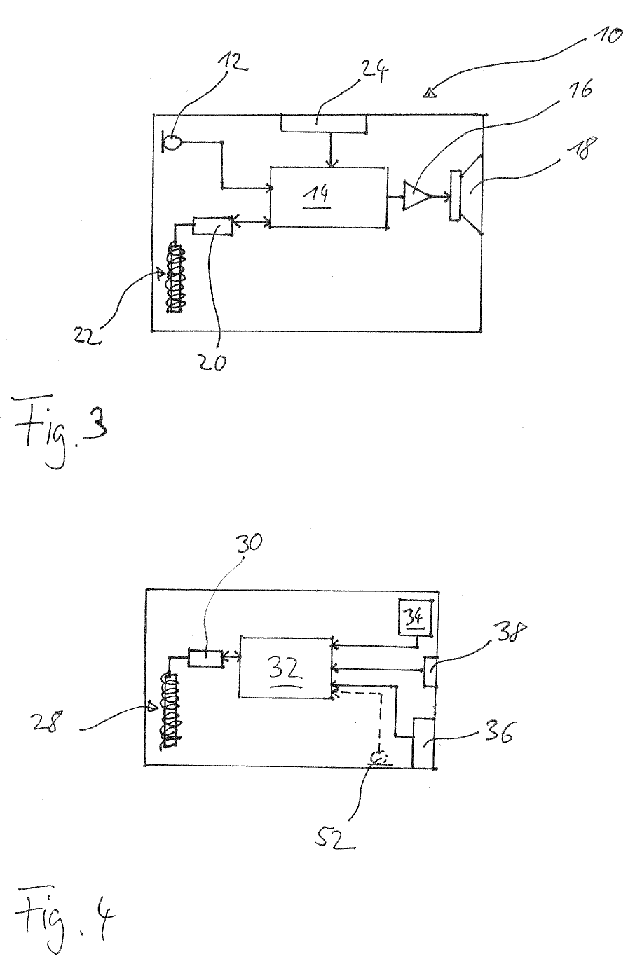

FIG. 3 shows a hearing aid 10 which may be used as a left ear unit 10A and a right ear unit 10B, respectively, of the binaural hearing assistance system of FIG. 1 or FIG. 2. The hearing aid 10 comprises a microphone 12 for picking up ambient sound, a central audio signal processing unit 14, a power amplifier 16 and a loudspeaker 18.

The hearing aid 10 further comprises a receiver/transmitter unit 20 and an inductive antenna 22 for establishing a wireless inductive link for bidirectional communication with the other one of the hearing aids 10 in order to realize a binaural system. The hearing aids 10A. 10B may exchange audio signals captured by the microphone 12 of the other one of the hearing aids 10A, 10B. Alternatively or in addition, the hearing aids 10A, 10B may exchange control data generated by the audio signal processing unit 14 according to the audio signals from the microphone 12 or control data received by the central audio signal processing 14 from a control panel 24 provided at the hearing aid or from a remote control of the hearing aid.

The audio signal processing unit 14 usually will be able to perform auditory scene analysis in order to adapt the audio signal processing to the presently detected auditory scene, for example, in order to adjust the amplification and/or the degree of acoustic beam forming to the auditory scene (usually the microphone 12 will be a microphone arrangement consisting of at least two microphones which are spaced apart for acoustic beam forming). To this end, the audio signal processing unit 14 usually will select one audio program from a plurality of different audio programs depending on the presently captured audio signals.

In order to determine the present auditory scene, audio signal processing unit 14 in addition to the audio signals from the microphone 12 also may take into account audio signals received by the receiver/transmitter unit 20 from the other one of the hearing aids 10A, 10B, i.e. audio signals captured by the microphone 12 of the other one of the hearing aids 10A, 10B, in order to render the result of the auditory scene analysis more reliable. Moreover, information regarding the presently selected audio program may be exchanged between the bearing aids 10A, 10B, and such information regarding the presently selected audio program of the other one of the hearing aids 10A, 10B may be taken into account when selecting the audio program.

It is to be understood that the hearing aid 10 will include elements in addition to that shown in FIG. 3, such as a battery, a data/program memory, etc.

An example of a binaural hearing system is found in EP 1 651 005 A2.

The antenna 22 preferably is a coil which may comprise an elongated core such as a ferrite core or which may a simple air coil. The antenna 22 of at least one of the hearing aids 10A, 10B, in addition to establishing a bidirectional inductive link to the other one of the hearing aids 10A, 10B, also serves to establish an inductive link to a remote device 26 which is to be worn at the user's body.

In the embodiment of FIG. 1 the antenna 22 of the hearing aid 10A, 10b is oriented substantially vertical in such a manner that it is substantially parallel to the antenna 22 of the other one of the hearing aids 10A, 10B. In this case, the hearing aids 10A, 10B preferable are of the BTE type, with the antennas 22 substantially extending in the longitudinal direction of the hearing aid housing.

The communication between the hearing aid 10 and the remote device 26 via the inductive link may be unidirectional from the remote device 26 to the hearing aid 10, or it may be bidirectional if necessary. The remote device 26 may be a remote control for the hearing aid 10 in order to transmit manual control commands to the audio signal processing unit 14, and/or it may serve as an audio signal source for supplying audio signals to be reproduced by the loudspeaker 18 to the hearing aid 10. In the latter case, the remote device 26 may be a music player, such as an MP3 player, and/or a radio broadcast receiver. Alternatively, the remote device 26 may comprise a microphone for capturing audio signals from ambient sound and/or it may be electrically connected to an audio signal source to be worn at the user's body, such as a radio frequency (RF) receiver unit or a mobile phone.

FIG. 4 is a block diagram of an example of such a remote device 26 which comprises an inductive antenna 28, which preferably comprises a coil which preferably has an elongated core such as a ferrite core, a transmitter unit 30, a central processing unit 32, an audio signal source 34 (for example, a digital audio data storage medium), a control panel 36 and an audio signal input 38. The control panel 36 serves for manual input of control commands for the hearing aid 10. The audio signal input 38 serves to connect the remote device 26 to an audio signal source, such as a radio frequency receiver or a mobile phone, via a wired connection or a wireless interface. The remote device 26 also may comprise a microphone 52 for capturing ambient sound.

FIG. 1 shows examples of a binaural hearing assistance system comprising two hearing aids 10A and 10B wherein the antenna 22 is oriented substantially vertically and some examples of remote devices 26A to 26F which are designed in such a manner that the antenna 28 is oriented substantially vertically—and thus essentially parallel to the antennas 22 of the hearing aids 10A, 10B—when the hearing aids 10A, 10B and the remote devices 26 are worn according to specification.

As a first example, a remote device 26A is shown which is to be worn around the user's neck in such a manner that due to the action of gravity the antenna 28 of the device 26A is oriented essentially vertical.

A device 26B has a pen-shaped housing which is to be worn in, for example, a shirt pocket, with the antenna 28 extending along the longitudinal axis of the housing.

A device 26C is to be fixed at the user's upper arm by a band 40 extending around the user's upper arm, with the antenna 28 extending perpendicular to the band 40.

A device 26D is designed to be worn at a belt 42 worn by the user, with the antenna 28 extending in the direction perpendicular to the belt 42.

The above-described devices 26A to 26D have an antenna 28 which may be designed as a coil comprising an elongated core such as a ferrite core. However, in some cases the antenna 28 may be designed as air coil. For example, an inductive antenna may be integrated within the band 40 in such a manner that an air coil is wound around the user's upper arm when the band 40 is worn by the user. This embodiment is shown in dashed lines in FIG. 1, with the remote device being designated by 26E. According to another example, the air coil may be integrated within the belt 42 in such a manner that the air coil is wound around the user's hip when the belt 42 is worn by the user. This device is designated by 26F.

According to FIG. 1 the system in addition may comprise a remote desktop device 26I comprising a printed circuit board 50 into which an inductive antenna 28 is embedded which is formed by conductor turns within the plane of the printed circuit board 50, wherein desktop device 26I is designed in such a manner that the printed circuit board 50 is oriented parallel to the plane in which the desktop device 26I is placed.

The system also may comprise a handheld device 26J comprising a printed circuit board 50 into which a first inductive antenna 28 is embedded which is formed by conductor turns within the plane of the printed circuit board 50 and a second inductive antenna 128, preferably comprising a coil having an elongated core, having an axial symmetry axis which is oriented along or parallel to a longitudinal axis of the handheld device 26J. Preferably, the axial symmetry of the second antenna 128 is oriented in or parallel to the plane of the printed circuit board 50.

In FIG. 2 an alternative embodiment of a binaural hearing assistance system is shown wherein the antennas 22 of the hearing aids 10A, 10B are oriented essentially horizontally and aligned with respect to each other. In this case, a remote device 26G may be used which is to be worn at the user's chest where it may be fixed, for example, by an appropriate band (not shown), wherein the antenna 28 is oriented essentially horizontally and parallel to the antennas 22 of the hearing aids 10A, 10B. According to another example, the remote device 26H may have a wrist watch-like design, with the band 44 of the wrist watch serving as an air coil, i.e. the coil will be integrated within the band 44 in such a manner that it is bound around the user's wrist.

In the case of FIG. 2 the hearings aids 10A, 10B preferably are of the ITE type, with the antennas 22 extending in the longitudinal direction of the hearing aid housing.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. A system for providing binaural hearing assistance to a user, comprising a left ear unit to be worn at or in a user's left ear, a right ear unit to be worn at or in a user's right ear, each of said left ear unit and the right ear unit comprising means for stimulating a user's hearing and an inductive antenna for enabling bidirectional communication between said left ear unit and said right ear unit via an inductive link, which antenna has an axial symmetry axis which is oriented substantially vertically and which is substantially parallel to said antenna of the other one of said left ear unit and right ear unit, the system further comprising at least one device to be worn by said user which comprises an inductive antenna for enabling communication between said device and at least one of said left ear unit and said right ear unit via an inductive link, which antenna has an axial symmetry axis which is oriented substantially vertically and which is substantially parallel to said antennas of said left ear unit and right ear unit.

2. The system of claim 1, wherein each of said left ear unit and said right ear unit is a hearing aid comprising a microphone for capturing audio signals from ambient sound which are processed by an audio signal processing unit and are supplied to said stimulating means.

3. The system of claim 2, wherein each of said left ear unit and said right ear unit is a behind-the-ear hearing aid.

4. The system of claim 1, wherein said device is to be worn around a user's neck.

5. The system of claim 1, wherein said device has a pen-shaped housing, with said antenna extending along an axis of said housing, and wherein said pen-shaped housing is adapted to be fixed to a user's clothing.

6. The system of claim 1, wherein said device is a belt-worn device, with said antenna extending perpendicular to the belt.

7. The system of claim 1, wherein said device is adapted to be fixed at a user's upper arm by a band, with said antenna extending perpendicular to said band.

8. The system of claim 1, wherein said antenna of said device comprises a coil.

9. The system of claim 8, wherein said coil of said antenna of said device surrounds an elongated core.

10. The system of claim 1, wherein said device to be worn by said user is attached to a belt, wherein the antenna is integrated within said belt in such a manner that it is wound as an air coil around a user's hip.

11. The system of claim 1, wherein said device to be worn by said user is attached to a band to be worn around a user's upper arm, wherein said antenna is integrated within said band in such a manner that it is wound as an air coil around said user's upper arm.

12. The system of claim 1, wherein the system comprises a desktop device comprising a printed circuit board into which all inductive antenna is embedded which is formed by conductor turns within a plane of said printed circuit board, wherein said printed circuit board is oriented parallel to a plane on which said desktop device is to be placed.

13. The system of claim 1, wherein the system comprises a handheld device comprising a printed circuit board into which a first inductive antenna is embedded which is formed by conductor turns within a plane of said printed circuit board and a second inductive antenna having an axial symmetry axis which is oriented along or parallel to a longitudinal axis of said handheld device.

14. The system of claim 13, wherein an axial symmetry axis of said second antenna is oriented in or parallel to said plane of said printed circuit board.

15. The system of claim 13, wherein said second antenna comprises a coil.

16. A system for providing binaural hearing assistance to a user, comprising a left ear unit to be worn at or in a user's left ear, a right ear unit to be worn at or in a user's right ear, each of said left ear unit and said right ear unit comprising means for stimulating a user's hearing and an inductive antenna for enabling bidirectional communication between said left ear unit and said right ear unit via an inductive link, which antenna has an axial symmetry axis which is oriented substantially horizontally and which is substantially aligned to said antenna of said other one of the left ear unit and right ear unit, the system further comprising at least one device to be worn by said user which comprises an inductive antenna for enabling communication between said device and at least one of said left ear unit and said right ear unit via an inductive link, which antenna has an axial symmetry axis which is oriented substantially horizontally and which is substantially parallel to said antennas of said left ear unit and right ear unit.

17. The system of claim 16, wherein each of said left ear unit and said right ear unit is a hearing aid comprising a microphone for capturing audio signals from ambient sound which are processed by an audio signal processing unit and are supplied to said stimulating means.

18. The system of claim 16, wherein said device to be worn by said user is a wrist watch-like device, wherein said antenna is integrated within a wrist band in such a manner that it is wound as an air coil around a user's wrist.

19. The system of claim 16, wherein said device to be worn by said user is to be worn at a user's chest and wherein said antenna of said device comprises a coil.

20. The system of claim 1, wherein said antenna of each of said left ear unit and said right ear unit comprises a coil.

21. The system of claim 20, wherein said coil of said antenna of each of said left ear unit and said right ear unit surrounds an elongated core.

22. The system of claim 1, wherein said means for stimulating said user's hearing is a loudspeaker oriented towards a user's ear drum.

23. The system of claim 1, wherein the communication between said device and at least one of said left ear unit and said right ear unit is bidirectional.

24. The system of claim 1, wherein said device to be worn by said user serves as a remote control for said left ear unit and said right ear unit.

25. The system of claim 1, wherein said device to be worn by said user serves as a remote audio signal source for said left ear unit and said right ear unit.

26. The system of claim 25, wherein said device is at least one of a music player and a radio.

27. The system of claim 1, wherein said device comprises a microphone for capturing audio signals from ambient sound which are transmitted to at least one of said right ear unit and said left ear unit.

28. The system of claim 1, wherein said device is adapted to be electrically connected to an audio signal source to be worn at said user's body.

29. The system of claim 28, wherein said audio signal source is a radio frequency receiver unit or a mobile phone.
